(19) United States
(12) Patent Application Publication
(10) Pub. No.: US 2026/0117036 A1
(43) Pub. Date: Apr. 30, 2026

(54) METHOD FOR PREPARING THERMOSETTING MIDSOLES USING FOAMED PARTICLES

(71) Applicant: MAOTAI (FUJIAN) NEW MATERIAL TECHNOLOGY CO., LTD, Jinjiang (CN)

(72) Inventors: Sibo DING, Jinjiang (CN); Xin LU, Jinjiang (CN); Yibin LIAO, Jinjiang (CN); Yuling WANG, Jinjiang (CN); Sien DING, Jinjiang (CN); Weizhi ZHUANG, Jinjiang (CN); Rongda ZHENG, Jinjiang (CN); Jiankun LIN, Jinjiang (CN); Wenping CHEN, Jinjiang (CN); Yan WANG, Jinjiang (CN)

(73) Assignee: MAOTAI (FUJIAN) NEW MATERIAL TECHNOLOGY CO., LTD, Jinjiang (CN)

(21) Appl. No.: 18/933,525

(22) Filed: Oct. 31, 2024

(51) Int. Cl. C08J 9/224; B29C 44/34; B29K 75/00; B29L 31/50; C08J 9/00; C08J 9/12; C08J 9/18; C08J 9/232; C08L 75/06; C08L 75/08

(52) U.S. Cl. CPC C08J 9/224; C08J 9/0061; C08J 9/122; C08J 9/18; C08J 9/232; C08L 75/06; C08L 75/08; B29C 44/3426; B29K 2075/00; B29L 2031/504; C08J 2203/08; C08J 2375/06; C08J 2375/08; C08J 2423/08; C08J 2467/00; C08J 2477/00; C08L 2203/14

(57) ABSTRACT

The present application relates to a method for preparing a thermosetting midsole using foamed particles with graphene oxide on surface. The method comprises: fusing the foamed particles with graphene oxide on surface with each other in a midsole mold under steam heating conditions to form the thermosetting midsole, wherein the body of the foamed particles with graphene oxide on surface is formed by mixing 60 wt % to 95 wt % thermoplastic polyurethane and 5 wt % to 40 wt % thermosetting polymer and foaming under non curing conditions. Thermosetting midsoles have high mechanical strength, good thermal stability, good chemical resistance, and good breathability, making them suitable for outdoor and extreme environments. The graphene oxide on the surface of the foamed particles prevents the foamed particles from fusing with other foamed particles where graphene is present, thus naturally leaving breathable channels.

### TECHNICAL FIELD

This application relates to a method for preparing a thermosetting midsole, and a thermosetting midsole prepared using the method, specifically to a method for preparing a thermosetting midsole with improved breathability, wherein the thermosetting midsole optionally has an integrated visual effect.

### BACKGROUND

The appearance of popcorn shoe soles is formed by thousands of tightly arranged “popcorn”. The full name of this sole material is polyurethane thermoplastic elastomer, also known as ETPU sole. Its production principle is to hold each TPU particle at high temperature and pressure, increasing the volume of particles originally about 0.5 mm in size by about 10 times, forming elliptical non crosslinked foamed particles ETPU containing micro sealed bubbles. These particles resemble “popcorn” and are named after it. These elliptical non crosslinked foamed particles of miniature sealed bubbles are tightly arranged, forming the unique appearance and structure of popcorn shoe soles.

Supercritical foaming molding technology has been widely applied in shoe materials, and this process has gradually become a “super technology” trend in the field of shoe materials, slowly pushing it to the market. TPU shoe materials using supercritical foaming technology have become one of the most high-end shoe materials.

However, although TPU soles have good tear strength and elasticity, their breathability is relatively poor, which may lead to wet, stuffy, smelly feet, and even athlete's foot problems.

Various shoe soles with breathable holes have been designed in existing technology, but these soles may also damage the strength of the sole to some extent, and the wearer's feet may feel the breathable holes on the sole, which affects the comfort of wearing.

Moreover, in the manufacturing process of TPU shoe soles, breathable holes can generally only be prefabricated during the molding process, and it is best not to manufacture breathable holes after the sole is molded. This is because the manufacture of these breathable holes will damage the structure of the popcorn unit and affect the strength of the popcorn around the breathable holes. This is because the skin of the popcorn unit usually has the highest strength, and the internal bubbles are protected by the skin. When the skin is damaged, the strength around the breathable holes will deteriorate.

There is no existing technology that is both breathable and able to maintain good tear strength and elasticity of TPU shoe materials.

In addition, in existing technologies, popcorn shoe soles are made of thermoplastic materials. However, thermoplastic materials have relative poor thermal stability, support performance, and chemical resistance, and are not suitable for applications with high thermal stability, chemical resistance, and support performance, such as outdoor sports scenes with extreme conditions.

### SUMMARY

In view of this, the present application provides a method for preparing a thermosetting midsole using foamed particles. The thermosetting midsole prepared by the method has good breathability, while still retaining the good tear strength and elasticity of the popcorn midsole shoe material in the prior art. At the same time, it has good thermal stability, chemical resistance, and support performance.

The present application includes the following contents:

Embodiment 1: Method for preparing a thermosetting midsole using foamed particles with graphene oxide on surface, the method comprising:

Fusing the foamed particles with graphene oxide on surface with each other in a midsole mold under steam heating conditions to form the thermosetting midsole, wherein the body of the foamed particles with graphene oxide on surface is formed by mixing 60 wt % to 95 wt % of thermoplastic polyurethane and 5 wt % to 40 wt % of thermosetting polymer of the foamed particles and foaming under non curing conditions.

Among the foamed particles with graphene oxide on surface, 5 wt % to 40 wt % are thermosetting. Thermoplastic polymers are easy to process and reuse, but their thermal stability is poor; thermosetting polymers are difficult to process, but they have good thermal stability and chemical resistance. The thermosetting midsole prepared according to Embodiment 1 has high mechanical strength, good thermal stability, good chemical resistance, good breathability, and is suitable for outdoor and extreme environments. Thermosetting midsoles have better support performance. In the production of various outdoor shoe materials that require high support performance, midsoles need to have high support performance. The midsole of this application is particularly suitable for this application scenario. During the high-temperature fusion process of graphene oxide on the surface of foamed particles, the graphene oxide itself forms stable chemical bonds with the reactive groups on the surface of the foamed particles. Graphene has a multi-layered structure, which prevents the foamed particles from fusing with other foamed particles in areas with graphene, thus naturally leaving breathable channels. FIG. 1 is a schematic diagram of the theoretical ventilation channel.

In this application, the hydrophilic groups of graphene oxide can react with reactive groups on polyurethane to form stable links, while the hydrophobic structure on the other side prevents the foamed particles from fusing in some areas, leaving naturally formed breathable channels on the formed midsole. This channel is mainly formed by grapheme oxide. It can not only increase the breathability of the midsole, but also utilize the strong adsorption performance of graphene to achieve odor prevention of the sole.

Embodiment 2: The method for preparing a midsole using foamed particles according to Embodiment 1, wherein the amount of graphene oxide is 0.05 wt % to 2 wt % of the foamed particles.

Due to the small amount of graphene oxide added, it does not affect the bonding strength between foamed particles, and the remaining breathable channels can effectively increase the breathability of the midsole.

Embodiment 3: The method for preparing a midsole using foamed particles according to Embodiment 1, wherein the foamed particles with graphene oxide on surface are prepared as follows: a mixture of 60 wt % to 95 wt % thermoplastic polyurethane and 5 wt % to 40 wt % thermosetting polymer is foamed under non curing conditions to form the body of the foamed particles, based on the total weight of the body of the foamed particles; Contact the suspension of graphene oxide with the body of the foamed particles to obtain foamed particles with graphene oxide on surface.

Physically combining graphene oxide with foamed particles in the form of a suspension, a strong chemical bond is formed during the secondary foaming process.

Embodiment 4: The method for preparing a midsole using foamed particles according to Embodiment 1, wherein the foamed particles with graphene oxide on surface are prepared as follows: a mixture matrix is formed by mixing 60 wt % to 95 wt % of thermoplastic polyurethane and 5 wt % to 40 wt % of thermosetting polymer in a molten state; mix the molten mixture matrix with the supercritical foaming agent (such as carbon dioxide or nitrogen gas) to form a single-phase mixed sol;

Pass the single-phase mixed sol through an extrusion die and enter a normal pressure state, thereby causing the foaming agent to precipitate a large number of bubble nuclei and expand, obtaining hot foaming particles,

Mixing powdered graphene oxide with the hot foamed particles, cooling to form foamed particles with graphene oxide on surface. It is easy for the hot foamed particles to adhere the graphene oxide in the form of solid powder.

The curing agent used in the thermosetting polymer of this application is not limited, and all curing agents known in the art can be used as long as the performance of the final midsole is not significantly degraded.

Embodiment 5: The method for preparing a midsole using foamed particles according to Embodiment 3, wherein the suspension of graphene oxide further contains a adhesive. The adhesive is to increase the adhesion between foamed particles.

Embodiment 6: The method for preparing a midsole using foamed particles according to Embodiment 2, wherein the graphene oxide is sulfonated graphene, and the sheet diameter of the sulfonated graphene is greater than or equal to 100 microns to less than 1000 microns; the respective thicknesses of the sulfonated graphene are 5 to 10 nanometers. In some embodiment, the thickness uniformity of the sulfonated graphene exceeds 90%. The sheet diameter uniformity of the sulfonated graphene exceeds 90%.

Embodiment 7: According to the method for preparing a midsole using foamed particles as described in Embodiment 1,
the midsole is a midsole with an integrated visual effect, and at least some areas of the midsole with an integrated visual effect have an integrated visual effect, that is, there is no popcorn like pattern in that area, which is called an integrated visual area,
characterized in that,

The mold is a porous mold, and the visual part corresponding to the integrated molding visual area is provided with multiple first ventilation holes, wherein the area of each first ventilation hole is 0.01 square millimeters to 0.25 square millimeters, and the number of first ventilation holes is greater than 50 per square centimeter,

The method comprises:
The first step is to place the foamed particles in the mold, introduce steam at a first temperature into the mold to perform secondary foaming on the foamed particles and fuse them together to form a midsole precursor,
The second step is to maintain one or more of the molds in an atmosphere at a second temperature, where the second temperature is higher than the first temperature, so that an integrated visual effect is formed in the integrated molding visual area of the midsole precursor, forming the midsole.

Dense breathable holes make it easier to obtain a surface that is more consistent with the mold surface. During high-temperature treatment, in the integrated molding visual area, the skin density increases and the tearing strength is improved. The popcorn pattern disappears and has an integrated molding effect, allowing for more complex and fine patterns to be set on its side without being affected by the disappeared popcorn pattern.

Embodiment 8. The method for preparing a midsole using foamed particles according to Embodiment 7, wherein the integrated visual effect comprises: the integrated visual area does not contain popcorn patterns, and the integrated visual area includes fine patterns, which are pattern features with a size of 0.2 mm to 2.0 mm, including one or more of protrusions, fine patterns, and depressions, and the size of the pattern feature refers to the minimum size of the pattern feature.

Embodiment 9. The method for preparing a midsole using foamed particles according to Embodiment 1, wherein the thermosetting polymer is selected from:

Thermosetting phenolic resin, thermosetting urea formaldehyde resin, thermosetting melamine formaldehyde resin, thermosetting epoxy resin, thermosetting polyimide, thermosetting polyether nylon elastomer (PEBax), thermosetting polyester elastomer (TPEE), thermosetting ethylene vinyl acetate polymer (EVA), and thermosetting polyurethane.

Embodiment 10. The method for preparing a midsole using foamed particles according to Embodiment 7, wherein the integrated visual effect area includes the side of the midsole.

Embodiment 11. The method for preparing a midsole using foamed particles according to Embodiment 7, wherein the mold is provided with multiple second ventilation holes for non visual parts that do not correspond to the visual area of the integrated molding. The area of each second ventilation hole is greater than 0.3 square millimeters and less than 3 square millimeters, and the number of second ventilation holes is less than 10 per square centimeter, for example, 0.5 to 3 per square centimeter.

The large breathable holes and small distribution quantity preserve the appearance of popcorn and some roughness, making it more suitable for bonding with other materials.

Embodiment 12. The method for preparing a midsole using foamed particles according to Embodiment 7, wherein the surface of the visual part of the mold has a smaller roughness than the surface of the non visual part, that is, the non visual part is rougher.

Rough edges are easier to bond with other shoe materials such as the outsole. And if the visual part is not rough, it can display better visual effects.

Embodiment 13. The method for preparing a midsole using foamed particles according to Embodiment 7, wherein the surface of the visual part of the mold is provided with fine patterns.

Embodiment 14. The method for preparing a midsole using foamed particles according to Embodiment 7,

The first temperature is between the softening point temperature of the foamed particles and a temperature 18° C. higher than the softening point temperature, and the processing time is 1 minute to 5 minutes,

The second temperature is a temperature that is 20° C. to 30° C. higher than the first temperature, and the processing time is 1 minute to 5 minutes.

Embodiment 15. The method according to Embodiment 1, wherein the polyurethane comprises aliphatic polyurethane, which is prepared by reacting a liquid composition comprising polyurethane generating components and reaction catalysts, wherein
The polyurethane generating components include A) isocyanate components and B) isocyanate reactive components,
The A) isocyanate component comprises one or more selected from the following: aliphatic diisocyanates and aliphatic polyisocyanates;
The B) isocyanate reactive components include:
B1) One or more organic polyols with a functionality of 2-3;
B2) Low molecular weight polyvinyl alcohol with a molecular weight of 300 to 10000,
the initial viscosity of the liquid composition at 25° C. is 50-5000 mPa·s (measured according to DIN EN 53019), and the molar ratio of NCO groups in the A) isocyanate component to OH groups in the B) isocyanate reactive component is 1.05:1-1.1:1.

The polyurethane made from this composition has a alkyl skeleton of polyvinyl alcohol and good biocompatibility. The polyurethane foam material has the effects of temperature resistance, good thermoplasticity, which can achieve stable and controllable molding of the polyurethane foam material at high temperatures. The aliphatic isocyanates used in this application are selected from the group consisting of hexamethylene diisocyanate, cyclohexene diisocyanate, isophorone diisocyanate, etc. The B1) one or more organic polyols used in this application are selected from the group consisting of pentaerythritol, ethylene glycol (EG), 1,2-propanediol, 1,4-butanediol, 1,6-hexanediol, neopentyl glycol (NPG), dipropylene glycol, trimethylolpropane (TMP), glycerol, diethylene glycol, methylpropane glycol, polyether polyol, polyether carbonate polyol, polyester polyol, polycarbonate diol, or vegetable oil-based polyol.

Embodiment 16. A midsole prepared according to any one of the methods described in Embodiment 1 to 15.

Embodiment 17. The midsole according to Embodiment 16, which is a midsole with integrated visual effects, wherein the midsole with integrated visual effects is made by secondary foaming foamed particles in a mold, and has at least some areas have integrated visual effects, that is, there is no popcorn like pattern in that area visually, which is called the integrated visual area.

Embodiment 18. The midsole according to Embodiment 17, wherein the integrated visual area includes a side of the midsole.

Embodiment 19. The midsole according to Embodiment 17, wherein the midsole further comprises an area visually having a popcorn like pattern, called a non integrated visual area, wherein the skin density of the integrated visual area is 1.1 times or higher than that of the non integrated visual area, and the skin density of the integrated visual area is 1.3 times or higher than that of the internal area of the midsole.

In the specific Embodiment, in the non integral visual area: the skin density is 0.17 g/cm³, and the density in the middle part is 0.15 g/cm³; In the integrated visual area: the skin density is around 0.195 g/cm³, with a middle density of 0.15 g/cm³.

Embodiment 20. A shoe comprising a midsole according to any one of embodiments 16 to 20.

Embodiment 21. A method for preparing shoes, comprising preparing a midsole according to any one of the methods described in embodiments 1 to 15.

In the method of the present application, during the high-temperature fusion process of foamed particles with graphene oxide on surface, the graphene oxide itself forms a three-dimensional chemical bond with the reactive groups on the surface of the foamed particles. Graphene has a multi-layered structure, which prevents the foamed particles from fusing with other foamed particles where graphene is present, thus naturally leaving a breathable channel. In this application, although it is not possible to form a continuous breathable channel in many cases, it is believed that even if only some pores are formed, they still have a certain breathable function. Therefore, in this application, “breathable channels” and “pores” have the same meaning and can be used interchangeably.

In present application, the hydrophilic hydroxyl groups of graphene oxide can react with reactive functional groups on polyurethane to form stable links, while the hydrophobic structure on the other side prevents the foamed particles from fusing in some region, leaving naturally formed breathable channels on the formed midsole. This channel is mainly formed by graphene oxide.

Due to the small amount of graphene oxide added, it does not affect the bonding strength between foamed particles, and the remaining breathable channels can effectively increase the breathability of the midsole. Due to the presence of graphene oxide, its strong adsorbent properties make the midsole have a good odor removal effect.

A certain amount of thermosetting polymer is added to the foamed particles in this application, which makes the prepared midsole have better thermal stability, chemical resistance, and support performance, making it suitable for outdoor sports scenes or production and life with extreme stripes.

The present application also provides a midsole with an integrated visual effect. In the method of manufacturing the midsole, a mold with dense breathable holes is used, which makes it easy to obtain a surface that is more consistent with the surface of the mold. During the high-temperature treatment process, in the integrated molding visual area, the skin density increases and the tear strength is improved. The popcorn pattern disappears and has an integrated effect, allowing for more complex and fine patterns to be set on its side without being affected by popcorn patterns. This method still retains the excellent elasticity of the disappeared popcorn midsole.

In addition, the technical solution of the present application also brings many other advantages, which will be explained in detail in the specific embodiments.

It should be understood that the above general description and the subsequent detailed description are only exemplary and do not limit the present application.

### BRIEF DESCRIPTION OF THE DRAWINGS

In order to more clearly illustrate the technical solution of the embodiments of the present application, a brief introduction will be given to the accompanying drawings of the embodiments. It is obvious that the accompanying drawings described below only relate to some embodiments of the present application, and do not limit the present application.

FIG. 1 is a schematic diagram of the increased permeability caused by the use of graphene oxide;

FIG. 2 is a photo of sparse holes in the mold at the non integrated visual effect area; and

FIG. 3 is a photo of the dense holes in the mold at the integrated visual effect area.

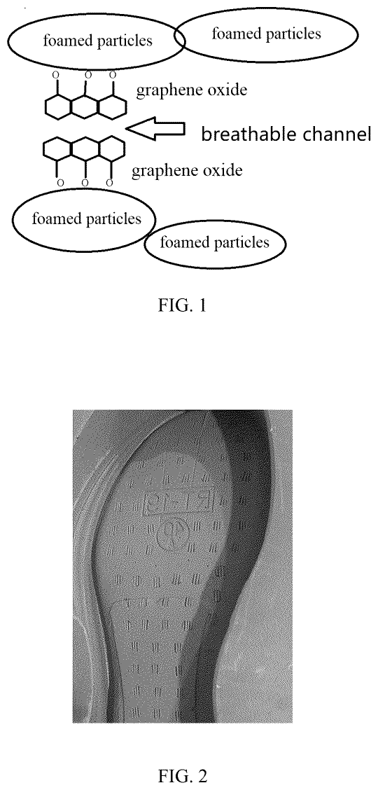

### EMBODIMENTS

The example embodiments will now be described more comprehensively with reference to the accompanying drawings. However, the example embodiments can be implemented in various forms and should not be construed as limited to the embodiments described herein; On the contrary, providing these embodiments makes the present application comprehensive and complete, and fully conveys the concept of the exemplary embodiments to those skilled in the art. The same reference numerals in the figure indicate the same or similar parts, so repeated descriptions of them will be omitted.

In addition, the described features, structures, or characteristics may be combined in any suitable manner in one or more embodiments. In the following description, many specific details are provided to provide a thorough understanding of the embodiments of the present application. However, those skilled in the art will appreciate that the technical solution of the present application may be practiced without one or more specific details, or other methods, components, devices, steps, etc. may be employed. In other cases, well-known methods, devices, implementations, or operations are not shown or described in detail to avoid obscuring aspects of the present application.

In this application, “wt %” represents the percentage of mass/weight.

Note: In this application, “quality” and “weight” have the same meaning.

Graphene oxide is the oxide of graphene, generally represented by GO, with a brownish yellow color. Common products on the market include powder, sheet, and solution forms. Due to the increase of oxygen-containing functional groups on graphene after oxidation, its properties are more reactive than graphene, and can be improved through various reactions with oxygen-containing functional groups. The graphene oxide referred to in this application refers to a sheet-like graphene with 5 to 30 layers of single-layer graphene (i.e., a thickness of about 1.5 nanometers to 15 nanometers), which is connected with functional groups that can bind with reactive groups. The preferred graphene oxide in this application is sulfonated graphene. WO2015184843A1 discloses a method for preparing sulfonated graphene from organic materials and sulfonated graphene. The graphene prepared by this method can have the following structural features: the sulfonated graphene has a sheet diameter (planar diameter of the material) of greater than or equal to 100 micrometers to less than 1000 micrometers; The respective thicknesses of the sulfonated graphene are 5 to 10 nanometers; And the thickness uniformity of the sulfonated graphene (the distance in the normal direction of the material plane) exceeds 90%; The sheet diameter uniformity of the sulfonated graphene exceeds 90%.

The first aspect of the present application provides a method for preparing a thermosetting midsole using foamed particles with graphene oxide on surface. The method comprises: fusing the foamed particles with graphene oxide on surface in a midsole mold under steam heating conditions to form the thermosetting midsole, wherein the body of the foamed particles with graphene oxide on surface is formed by mixing 60 wt % to 95 wt % thermoplastic polyurethane and 5 wt % to 40 wt % thermosetting polymer and foaming under non curing conditions, based on the weight of the body of the foamed particles.

5 wt % to 40 wt % of the foamed particles with graphene oxide on surface are thermosetting. Thermoplastic polymers are easy to process and reuse, but their thermal stability is poor. Thermosetting polymers are difficult to process, but they have good thermal stability and chemical resistance. The thermosetting midsole prepared in this application had high mechanical strength, good thermal stability, good chemical resistance, and good breathability. It is suitable for outdoor and extreme environments, such as desert high temperature weather conditions or high temperature production environments. Thermosetting midsoles have better support performance. In the production of various outdoor shoe materials that require high support performance, midsoles need to have high support performance. The midsole of this application is particularly suitable for this application scenario. During the high-temperature fusion process of foamed particles with graphene oxide on surface, the graphene oxide itself forms stable chemical bonds with the reactive groups on the surface of the foamed particles. Graphene oxide has a multi-layered structure, which prevents the foamed particles from fusing with other foamed particles in areas with graphene, thus naturally leaving breathable channels. The breathable channel is made into the midsole of the shoe, and the wearer can fully release the breathability of the midsole by wearing it for about 30000 steps (slightly different for different people).

Although the amount of thermosetting polymer used can vary according to the required performance during actual use, the use of thermosetting polymer should generally not be too high to avoid excessive hardness and poor resilience of the entire midsole. The resilience referred to in this application has the meaning commonly understood by those skilled in the art, which refers to the performance of the specimen to bounce up the impact object after being deformed by impact. In some embodiments, the body of foamed particles with graphene oxide on surface is formed by mixing 80 wt % to 95 wt % thermoplastic polyurethane and 5 wt % to 20 wt % thermosetting polymer and foaming under non curing conditions. In some embodiments, the body of foamed particles with graphene oxide on surface is formed by mixing 60 wt % to 80 wt % thermoplastic polyurethane and 20 wt % to 40 wt % thermosetting polymer and foaming under non curing conditions. In this application, the preparation of foamed particles should be carried out under non curing conditions of thermosetting polymers. This is because if the curing is carried out too early, the foamed particles will form a cured polymer three-dimensional network, which may prevent secondary foaming to form the midsole. In the process of secondary foaming, there is no such limitation because the thermosetting polymer undergoes at least partial curing, resulting in high mechanical strength, good thermal stability, and good chemical resistance of the obtained midsole.

In this application, the hydrophilic hydroxyl groups of graphene oxide can react with reactive groups on polyurethane to form stable links, while the hydrophobic structure on the other side prevents the foamed particles from fusing in some areas, leaving naturally formed breathable channels on the formed midsole. This channel is mainly formed by graphene.

In addition, due to the presence of graphene, its strong adsorption performance makes the midsole have a good odor removal effect. In this application, the evaluation of the breathability and odor removal effect of the midsole was conducted in the same experiment. In fact, it is often difficult for wearers to distinguish between breathability and odor removal effects. After wearing shoes, the amount of odor left behind decreases. It is not necessary for wearers to distinguish whether it is caused by adsorption or gas flow. Therefore, in this application, the evaluation of odor prevention is mainly conducted to simultaneously assess the odor removal ability and breathability of the midsole.

In some embodiments, the method of preparing a midsole using foamed particles is described, wherein the amount of graphene oxide is 0.05 wt % to 2 wt % of the foamed particles, i.e., the mass/weight of graphene oxide is 0.05% to 2% of the mass/weight of the foamed particles, that is, based on the weight of the body of the foamed particles. Within this range, the amount added can be 0.06 wt % to 1 wt %, such as 0.07 wt % to 0.5 wt %, 0.08 wt % to 0.4 wt %, 0.09 wt % to 0.3 wt %, or 0.1 wt % to 0.2 wt %.

Due to the small amount of graphene oxide added, it does not affect the bonding strength between foamed particles, and the remaining breathable channels can effectively increase the breathability of the midsole.

In some embodiments, the method for preparing a midsole using foamed particles is described, wherein the foamed particles with graphene oxide on surface are prepared as follows: a mixture of 60 wt % to 95 wt % thermoplastic polyurethane and 5 wt % to 40 wt % thermosetting polymer is foamed under non curing conditions to form a foam particle body, based on the total weight of the initial foamed particles; Contact the suspension of graphene oxide with the body of the foamed particles to obtain foamed particles with graphene oxide on surface. In these embodiments, graphene oxide is physically combined with foamed particles in the form of a suspension, forming a strong chemical bond during the secondary foaming process.

In some embodiments, the method of preparing a midsole using foamed particles is described, wherein the foamed particles with graphene oxide on surface are prepared as follows: a mixture of 60 wt % to 95 wt % thermoplastic polyurethane and 5 wt % to 40 wt % thermosetting polymer is mixed to form a molten mixed matrix; Fully mix the molten mixture matrix with the supercritical foaming agent (such as carbon dioxide or nitrogen gas) to form a single-phase mixed sol;
Pass the single-phase mixed sol through an extrusion die and enter a normal pressure state, thereby causing the foaming agent to precipitate a large number of bubble nuclei and expand, obtaining hot foamed particles,
Mixing powdered graphene oxide with the hot foamed particles, cooling to form foamed particles with graphene oxide on surface.

In these embodiments, the graphene oxide in the form of solid powder is combined with hot foamed particles, which are easy to adhere, and the resulting foamed particles with graphene oxide on surface can be directly used to form the midsole.

In some embodiments, the method of preparing a midsole using foamed particles, wherein the suspension of graphene oxide further contains an adhesive. The added adhesive is used to increase the adhesion between the foamed particles and make up for the reduced adhesion between foamed particles that may be caused by graphene oxide.

In some embodiments, the method for preparing a midsole using foamed particles is described, wherein the graphene oxide is sulfonated graphene, and the sheet diameter (planar diameter of the material) of the sulfonated graphene is greater than or equal to 100 micrometers to less than 1000 micrometers; The respective thicknesses of the sulfonated graphene are 5 to 10 nanometers; And the thickness uniformity of the sulfonated graphene (the distance in the normal direction of the material plane) exceeds 90%; The sheet diameter uniformity of the sulfonated graphene exceeds 90%.

The sulfonated graphene specifically used in this application is a type of graphene oxide, which is oxidized by sulfonation and prepared according to the specific method disclosed in Example 4 of WO2015184843A1.

In the method of this application, when thermosetting polymers are used, the prepared midsole is a thermosetting midsole. A person skilled in the art should understand that if the body of the foamed particles is replaced with a thermoplastic material such as thermoplastic polyurethane, a thermoplastic midsole can still be obtained, which still has excellent odor removal ability and breathability. Therefore, the midsole referred to in this application usually refers to a thermosetting midsole, and the terms “midsole” and “thermosetting midsole” can be used interchangeably; However, when all the polymer materials used for the midsole are thermoplastic materials, it refers to a thermoplastic midsole.

The method of this application can also be used to prepare midsoles with integrated visual effects. Usually, popcorn shoe soles do not have a one-piece visual effect. On the contrary, the popcorn visual effect can be clearly seen from the side of the shoe midsole. In some embodiments, the method for preparing a midsole using foamed particles is described, wherein the midsole is a midsole with an integrated visual effect, and at least a portion of the midsole with an integrated visual effect has an integrated visual effect, that is, there is no popcorn like pattern in that area, which is called an integrated visual area. The method is characterized in that the mold is a porous mold, and the visual part corresponding to the integrated visual area is provided with multiple first ventilation holes, where the area of each first ventilation hole is 0.01 square millimeters to 0.25 square millimeters, and the number of first ventilation holes is greater than 50 per square centimeter,

The method comprises:
The first step, place the foamed particles in the mold, introduce steam at a first temperature into the mold to perform secondary foaming on the foamed particles and fuse them together to form a midsole precursor,
The second step, maintain one or more of the molds in an atmosphere at a second temperature, where the second temperature is higher than the first temperature, so that an integrated visual effect is formed in the integrated molding visual area of the midsole precursor, to form the midsole.

This Embodiment has special technical effects. The dense breathable holes make it easy to obtain a surface that is more consistent with the surface of the mold. During the high-temperature treatment process, the skin density increases and the tear strength of the visual part is improved. The popcorn pattern disappears and has an integrated molding effect, allowing for more complex and fine patterns to be set on its surface without being affected by the popcorn pattern.

In some embodiments, the method of preparing a midsole using foamed particles is described, wherein the integrated visual effect comprises: the integrated visual area does not contain popcorn like patterns, and the integrated visual area includes fine patterns, which are pattern features with a size of 0.2 mm to 2.0 mm, including one or more of protrusions, fine patterns, and depressions, and the size of the pattern feature refers to the minimum size of the pattern feature.

The thermosetting polymer used in this application is not particularly limited, as long as it can achieve the technical effect of this application. In some embodiments, the method of preparing a midsole using foamed particles is described, wherein the thermosetting polymer is selected from the group consisting of thermosetting phenolic resin, thermosetting urea formaldehyde resin, thermosetting melamine formaldehyde resin, thermosetting epoxy resin, thermosetting polyurethane, thermosetting polyimide, thermosetting polyether nylon elastomer (PEBax), thermosetting polyester elastomer (TPEE), thermosetting ethylene vinyl acetate polymer (EVA), and thermosetting polyurethane. Thermosetting polymers can usually be obtained by mixing the polymer with curing agents (such as crosslinking agents) and optional additives (such as co crosslinking agents). For example, thermosetting ethylene vinyl acetate polymers are obtained by blending ethylene vinyl acetate polymers with 0.5 wt % to 0.8 wt % crosslinking agent TBEC and 0.6-0.8 wt % co crosslinking agent TAIC. Thermosetting polyurethane is obtained by blending uncapped polyurethane with amine/alcohol chain extenders. Thermosetting polyether nylon elastomer (PEBAX) is obtained by blending polyether nylon elastomer and chain extender, etc.

In some embodiments, the method of preparing a midsole using foamed particles, wherein the integrated visual effect area includes the side of the midsole.

In some embodiments, the method of preparing a midsole using foamed particles is described, wherein the mold is provided with multiple second air holes in non visual parts that do not correspond to the integrated visual area, and the area of each second air hole is greater than 0.3 square millimeters and less than 3 square millimeters, and the number of second air holes is less than 10 per square centimeter, for example, 0.5 to 3 per square centimeter.

In non visual areas, the mold uses large breathable holes with fewer distribution numbers, allowing the midsole to retain the appearance of popcorn and some roughness, which is more suitable for bonding with other materials.

In some embodiments, the method of preparing a midsole using foamed particles is described, wherein the surface of the visual part of the mold has a smaller roughness than the surface of the non visual part, i.e., the non visual part is rougher. In this implementation, rough edges are easier to bond with other shoe materials such as the outsole. And if the visual part is not rough, it can display better visual effects.

In some embodiments, the method of preparing a midsole using foamed particles is described, wherein the surface of the visual part of the mold is provided with fine patterns.

In some embodiments, the method of preparing a midsole using foamed particles is described,
The first temperature is between the softening point temperature of the foamed particles and a temperature 18° C. higher than the softening point temperature, and the processing time is 1 minute to 5 minutes,
The second temperature is a temperature that is 20° C. to 30° C. higher than the first temperature, and the processing time is 1 minute to 5 minutes.

In some embodiments, the polyurethane comprises aliphatic polyurethane, which is prepared by reacting a liquid composition comprising polyurethane generating components and reaction catalysts, wherein
The polyurethane generating components include A) isocyanate components and B) isocyanate reactive components,
The A) isocyanate component comprises one or more selected from the following: aliphatic diisocyanates and aliphatic polyisocyanates;
The B) isocyanate reactive components include:
B1) One or more organic polyols with a functionality of 2-3;
B2) Low molecular weight polyvinyl alcohol with a molecular weight of 300 to 10000,
the initial viscosity of the liquid composition at 25° C. is 50-5000 mPa·s (measured according to DIN EN 53019), and the molar ratio of NCO groups in the A) isocyanate component to OH groups in the B) isocyanate reactive component is 1.05:1-1.1:1.

The aliphatic polyurethane polymer prepared by this embodiment is particularly suitable for preparing the midsole described in this application. The polyurethane made from the composition disclosed by this method has a polyvinyl alcohol alkyl skeleton and good biocompatibility. The polyurethane foam material has good thermoplasticity, and stable shrinkage rate of the grinding tool, which can achieve stable and controllable molding of the polyurethane foam material at high temperatures.

The reaction catalyst is a latent catalyst that acts as a catalyst at a temperature of 60° C. to 100° C. The weight content of the reaction catalyst is 0.01 to 6 parts by weight, calculated based on 100 parts by weight of the polyurethane generating component.

The type of catalyst used in this application is not limited, as long as it is suitable for the chemical reaction in this application. In some embodiments, the reaction catalyst may be one or more of aromatic amines, imidazoles, anhydrides, dicyandiamides, organic hydrazide compounds, such as cyanoguanidine, 4,4′--diaminodiphenyl sulfone, N-acylimidazole compounds, and cyanoacetyl compounds. In specific Embodiments, catalysts that can be used include tertiary amines or organotin catalysts, such as N,N-dimethylcyclohexylamine, tetramethylethylenediamine, tetramethylbutanediamine, N,N′-dimethylpiperazine, triethanolamine and dimethylethanolamine, dimethylbenzylamine, N-ethylmorpholine, pentamethyldiethylenetriamine, and triethylamine. Organic tin catalysts include tin octoate.

The liquid composition may also include at least one additive selected from the following: defoamer, release agent, leveling agent, durability additive, flow additive, organic color powder, inorganic color powder, and color paste.

This application also provides a midsole prepared by any of the methods described herein.

In some embodiments, the midsole described in this application is a midsole with an integrated visual effect, wherein the midsole with an integrated visual effect is made by secondary foaming of foamed particles in a mold, and at least some areas have an integrated visual effect, that is, there is no popcorn like pattern in that area visually, which is called an integrated visual area.

In some embodiments, the integrated visual area in the midsole described in this application includes the side of the midsole.

In some embodiments, the midsole described in this application further includes an area visually having a popcorn like pattern, referred to as a non integrated visual area, wherein the skin density of the integrated visual area is 1.1 times or higher than that of the non integrated visual area, and the skin density of the integrated visual area is 1.3 times or higher than that of the internal area of the midsole. In the specific implementation, in the non integral visual area: the skin density is about 0.17 g/cm³, and the density in the middle part is 0.15 g/cm³; In the integrated visual area, the skin density is about 0.195 g/cm³, and the density in the middle part is 0.15 g/cm³. The skin portion referred to in this application refers to the part within 2 mm thickness of the midsole surface, while the middle portion refers to the part at a distance of 3 mm or more from the surface. Generally speaking, the density of the skin part is higher than that of the middle part. However, in this application, the skin density of the integrated visual area is higher than that of the non integrated visual area, further increasing the mechanical strength and toughness of the integrated visual area skin and enhancing the durability of the shoe.

In some embodiments, the method of preparing a midsole using foamed particles is described, wherein the thermosetting polymer is selected from the group consisting of thermosetting phenolic resin, thermosetting urea formaldehyde resin, thermosetting melamine formaldehyde resin, thermosetting epoxy resin, thermosetting polyurethane, thermosetting polyimide, thermosetting polyether nylon elastomer (PEBax), thermosetting polyester elastomer (TPEE), thermosetting ethylene vinyl acetate polymer (EVA), and thermosetting polyurethane.

In some embodiments, the foamed particles in the midsole described in this application contain:
80 wt % to 90 wt % of at least one of the following polyurethanes: polyester polyurethane, polyether polyurethane, aliphatic polyurethane, or a combination thereof; and
10 wt % to 20 wt % of the thermosetting polymer.

In some embodiments, the foamed particles in the midsole described in this application contain:
85 wt % to 95 wt % of at least one of the following polyurethanes: polyester polyurethane, polyether polyurethane, aliphatic polyurethane, or a combination thereof; and
5 wt % to 15 wt % of the thermosetting polymer.

The present application also provides a shoe comprising a midsole according to the present application.

The present application also provides a method for preparing shoes, which comprises preparing a midsole according to the method.

Generally speaking, thermosetting polymers undergo curing under certain curing conditions, including curing time and curing temperature. Taking thermosetting EVA resin as an example, the curing conditions of thermosetting EVA resin mainly include temperature and time. The curing process of thermosetting EVA resin is achieved by heating the crosslinking agent in EVA to generate free radicals, which in turn crosslink EVA molecules to form a three-dimensional network structure, thus completing the curing process. This process needs to be carried out at a certain temperature to ensure good fluidity of EVA resin, facilitate the formation of a uniform three-dimensional network structure, and thus achieve the desired performance. Specifically, the curing conditions for EVA resin include:

Curing temperature: At the curing temperature, EVA resin softens, and the foaming agent gas in the resin expands to further expand the foamed particles. At the same time, the crosslinking agent in EVA resin generates free radicals, and cross-linking reactions occur between EVA molecules, forming a three-dimensional network structure. At this time, the flowability deteriorates and the viscosity increases.

Curing time: The length of curing time depends on the specific curing conditions and the type of curing agent in EVA resin. Maintain at an appropriate temperature for a period of time to ensure sufficient cross-linking reaction and the formation of a stable network structure. In this application, since complete curing is not required, the curing time usually only takes 1-5 minutes.

It should be noted that excessive heating should be avoided during the curing process. If the temperature exceeds the curing temperature, the crosslinking agent may decompose and produce gas. At the same time, the crosslinking degree of EVA may decrease, which may lead to sulfurization, yellowing, shrinkage, and other phenomena.

This application will provide more specific embodiments through the following Examples.

### EXAMPLES

TABLE 1
Raw Materials and Sources

| | | |
|---|---|---|
| Raw material name | source | remarks |

| | |
|---|---|
| Polyester polyurethane | Zhejiang Huafeng Thermoplastic |
| | Polyurethane Co., Ltd |
| Polyether polyurethane | Zhejiang Huafeng Thermoplastic |
| | Polyurethane Co., Ltd |
| Aliphatic Polyurethane | Zhejiang Huafeng Thermoplastic |
| | Polyurethane Co., Ltd |
| Modified nylon elastomer | ARKEMA, a French company |
| PeBax | |
| Polyester elastomer TPEE | DuPont Company in the United States |
| Ethylene vinyl acetate | Taiwan Plastics Industry Co., Ltd |
| copolymer EVA | |
| Polyvinyl alcohol | Molecular weight 1000-1500, Shandong |
| | Hongquan Chemical Technology Co., Ltd |
| Graphene oxide (sulfonated | Made according to the method of |
| graphene) | WO2015184843A1 |
| Hexamethylene | Tianjin Aoluoqi Chemical Technology |
| diisocyanate | Co., Ltd |
| Polyisocyanates | Wanhua Chemical Group Co., Ltd., with |
| | an NCO content of 21.5-22.1% and a |
| | functionality of 3, trade name |
| | WANNATE HT-100 |
| Dipropylene glycol | Shandong Langyi Chemical Co., Ltd |
| Polyether polyol 1 | Model: WANOL S3007, using glycerol as |
| | the initiator and epichlorohydrin as the |
| | main polymerization reaction, hydroxyl |
| | value: 330, functionality: 3, viscosity at |
| | 25° C.: 300 mPa · s, purchased from |
| | Wanhua Chemical Group Co., Ltd |
| TBEC | Jiangsu Xinsu New Materials Co., Ltd |
| TAIC | Jiangsu Xinsu New Materials Co., Ltd |

### Example 1 [Method for Preparing Aliphatic Polyurethane]

The polyurethane used in this application is aliphatic polyurethane, which is prepared by reacting a liquid composition which comprisespolyurethane generating components and reaction catalysts, wherein the polyurethane generating components include A) isocyanate components and B) isocyanate reactive components,
the A) isocyanate component comprises one or more selected from the following: aliphatic diisocyanates and aliphatic polyisocyanates;
the B) isocyanate reactive components include:
B1) One or more organic polyols with a functionality of 2-3;
B2) Low molecular weight polyvinyl alcohol with a molecular weight of 300 to 10000,
the initial viscosity of the liquid composition at 25° C. is 50-5000 mPa·s (measured according to DIN EN 53019), and the molar ratio of NCO groups in the A) isocyanate component to OH groups in the B) isocyanate reactive component is 1.05:1-1.1:1.

The reaction catalyst is a latent catalyst that acts as a catalyst at a temperature of 60° C. to 100° C. The weight content of the reaction catalyst is 0.01 to 6 parts by weight, calculated based on 100 parts by weight of the polyurethane generating component.

Specifically, first, 30 parts by weight of hexamethylene diisocyanate and 30 parts by weight of polyisocyanate are mixed at room temperature to form the A) isocyanate component as liquid 1, and 0.3 parts by weight of stannous octoate and 0.2 parts by weight of N, N-dimethylcyclohexylamine are added as chemical reaction catalysts to the liquid 1. Then, 40 parts by weight of polyvinyl alcohol, 19 parts by weight of dipropylene glycol, and polyether polyol 1 are added to liquid 1 and mixed evenly to obtain the liquid composition. The initial viscosity of the liquid composition at 25° C. is measured to be 300 mPa·s (according to DIN EN 53019), and the molar ratio of NCO groups in the A) isocyanate component to OH groups in the B) isocyanate reactive component is about 1.08:1. Raise the temperature of the liquid composition to 70° C. under stirring to start the reaction, maintain the temperature of the reaction system below 130° C. for about 1 hour until the viscosity no longer increases, stop the reaction, cool and granulate to obtain aliphatic polyurethane in granular form, and its melting point to be 153° C.

The aliphatic polyurethane polymer prepared by this embodiment is particularly suitable for preparing the midsole described in this application. The polyurethane made from the composition disclosed by this method has a polyvinyl alcohol alkyl skeleton and good biocompatibility. The polyurethane foam material has at least the effects of temperature resistance, good thermoplasticity, and stable shrinkage rate of the grinding tool, which can achieve stable and controllable molding of the polyurethane foam material at high temperatures.

### Example 2 [Preparation of Foamed Particles by First Foaming by Supercritical Fluid]

The granular aliphatic polyurethane obtained in Example 1 was with thermosetting polymer to prepare a composition, and then foamed particles are prepared by supercritical fluid foaming method.

The thermosetting polymer was thermosetting EVA, which was obtained by thoroughly mixing 100 parts by weight of EVA (melting point of 70° C.) with 0.5 parts by weight of crosslinking agent TBEC (tert butylperoxy-2-ethylethyl carbonate) and 0.6 parts by weight of crosslinking agent TAIC (triallyl isocyanurate) at 75° C.
85 parts by weight of the polyurethane particles obtained in Example 1 was mixed with 15 parts by weight of the thermosetting EVA at 155° C. to obtain a molten mixture matrix;
The molten mixture matrix was mixed with the supercritical foaming agent (carbon dioxide, temperature 65° C., pressure 200 bar) to form a single-phase mixed sol;
The single-phase mixed sol was extruded through an extrusion die and entered a normal pressure state, causing the foaming agent to precipitate a large number of bubble nuclei and expand, resulting in hot foamed particles with a size of 0.8 to 1.5 cm and a density of approximately 0.16 g/cm³.

### Example 3 [Combining Graphene Oxide Powder on the Basis of Example 2]

0.5 wt % of powdered graphene oxide based on the weight of polyurethane particles was mixed with the hot foamed particles, and cooled, and formed foamed particles with graphene oxide on surface. The foamed particles obtained here are the first type with graphene oxide surface.

In this embodiment, the powdered graphene oxide was bonded to the hot foamed particles in the form of solid powder, making it easy to adhere. In this embodiment, the graphene oxide was sulfonated graphene, wherein the sheet diameter (planar diameter of the material) of the sulfonated graphene was greater than or equal to 100 micrometers to less than 1000 micrometers; the thicknesses of the sulfonated graphene was 5 to 10 nanometers; and the thickness uniformity of the sulfonated graphene (the distance in the normal direction of the material plane) exceeded 90%; the sheet diameter uniformity of the sulfonated graphene exceeded 90%.

### Example 4: Setting Graphene Oxide on Foamed Particles Using Graphene Oxide Suspension

The hot foamed particles obtained in Example 2 were cooled to obtain foamed particles.

A suspension of graphene oxide was prepared by combining graphene oxide, sodium dodecyl sulfonate, and water.

The suspension of graphene oxide was mixed with the foamed particles and dried to obtain a second type of foamed particles with graphene oxide on surface.

Graphene oxide in the form of a suspension was physically combined with foamed particles, a strong chemical bond was formed during the secondary foaming process.

### Example 5 [Second Foaming with Water Vapor, Preparation of Midsole]

The foamed particles with graphene oxide on surface of the first or second type were fused with each other in a midsole mold under steam heating conditions to form the midsole.

The midsole was a midsole with an integrated visual effect, and at least a portion of the midsole had an integrated visual effect, that is, there was no popcorn like pattern in that area, which was called an integrated visual area. The mold was a porous mold, which corresponded to the visual part of the integrated visual area and was provided with multiple first ventilation holes. The area of each first ventilation hole was 0.01 square millimeters to 0.25 square millimeters, and the number of first ventilation holes was greater than 50 per square centimeter. The method comprised:
first step, the foamed particles was placed in the mold, and steam at 158° C. was introduced into the mold to cause secondary foaming and fusion of the foamed particles to form a midsole precursor,
The second step is to maintain one or more of the molds in an atmosphere of 180° C., so that an integrated visual effect is formed in the integrated molding visual area of the midsole precursor, forming the midsole 5-1 and 5-2. The midsole 5-1 is prepared using the first type of foamed particles with graphene oxide surface obtained in Example 3, and the midsole 5-2 is prepared using the second type of foamed particles with graphene oxide surface obtained in Example 4.
In this embodiment, the first temperature is 158° C., which is 5° C. higher than the softening point temperature of the foamed particles, and the processing time is 3 minutes,
The second temperature is 180° C., which is 22° C. higher than the first temperature, and the processing time is 3 minutes.

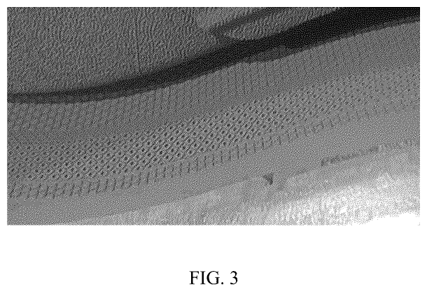

Specifically, in this embodiment, foamed particles with an average diameter of 12 mm formed by mixing polyester polyurethane and thermosetting polymer are placed into a 40 yard midsole mold, which is a porous mold with a breathable hole area of 0.01 square millimeters and a first breathable hole quantity of 100 per square centimeter. The mold is provided with multiple second ventilation holes in the non visual parts that do not correspond to the visual area of the integrated molding. The area of each second ventilation hole is 0.8 square millimeters, and the number of second ventilation holes is 3 per square centimeter. The non visual parts of the mold are rougher than the visual parts. FIGS. 2 and 3 are photos of the mold, showing sparse holes in the non integrated visual effect area and dense holes in the integrated visual effect area, respectively.

During the high-temperature fusion process of graphene oxide on the surface of foamed particles, the graphene oxide itself forms stable chemical bonds with the reactive groups on the surface of the foamed particles. Graphene has a multi-layered structure, which prevents the foamed particles from fusing with other foamed particles in areas with graphene, thus naturally leaving breathable channels.

In this application, the hydrophilic hydroxyl groups of graphene oxide can react with reactive groups on polyurethane to form stable links, while the hydrophobic structure on the other side prevents the foamed particles from fusing in some areas, leaving naturally formed breathable channels on the formed midsole. This channel is mainly formed by graphene.

Due to the small amount of graphene oxide added, it does not affect the bonding strength between foamed particles, and the remaining breathable channels can effectively increase the breathability of the midsole.

The technical effect of this embodiment is that the obtained thermosetting midsole has high mechanical strength, good thermal stability, and good chemical resistance. The dense ventilation holes in the midsole mold make it easier to obtain a surface that is more consistent with the mold surface. During the high-temperature treatment process, the skin density increases and the tear strength of the visual part is improved. The popcorn pattern disappears and has an integrated molding effect, allowing for more complex and fine patterns to be set on its side without being affected by the popcorn pattern. In the non integral visual area, the skin density is 0.17 g/cm³, and the density in the middle part is 0.15 g/cm³; In the integrated visual area, the skin density is 0.195 g/cm³, and the density in the middle part is 0.15 g/cm³.

### Example 6 [Shoe Making]

Produce shoe 5-1 and shoe 5-2 from midsole 5-1 and midsole 5-2 in Example 5, respectively.

The specific method is to bond the midsole with the rubber outsole, combine it with the shoe upper, and set the insole.

### Example 7 [Using the Particles Obtained in Example 2, Shoes were Directly Prepared without Adding Graphene Oxide]

Cool the hot foamed particles obtained in Example 2 to obtain foamed particles. Prepare the midsole using the method of Example 5, and manufacture shoes 5-3 using the method of Example 6.

### Example 8

The midsole was prepared using the method of Example 5, and the shoe was made using the method of Example 6, except that commercially available foamed particles (polyester polyurethane-A1, polyether polyurethane-A2, aliphatic polyurethane-A3, modified nylon elastomer Pebax-A4, polyester elastomer TPEE-A5, ethylene vinyl acetate copolymer EVA-A6) were used to obtain shoes A1, A2, A3, A4, A5, and A6.

### Example 9

The method of Example 4 was used to prepare foamed particles with graphene oxide on surface, except that commercially available foamed particles (polyester polyurethane-B1, polyether polyurethane-B2, aliphatic polyurethane-B3, modified nylon elastomer Pebax-B4, polyester elastomer TPEE-B5, ethylene vinyl acetate copolymer EVA-B6) were used to prepare foamed particles with graphene oxide on surface.

The midsole was prepared using the method of Example 5, and shoes were made using the method of Example 6, resulting in shoes B1, B2, B3, B4, B5, and B6.

### Comparative Example 10

The midsole was prepared using the method of Example 5, and the shoe was made using the method of Example 6, except that the following foamed particles were used (foam particle 5-4 from Example 2, polyester polyurethane-C1, polyether polyurethane-C2, aliphatic polyurethane-C3, modified nylon elastomer Pebax-C4, polyester elastomer TPEE-C5, ethylene vinyl acetate copolymer EVA-C6), and the second step was not carried out, that is, the step of “maintaining one or more of the molds in an atmosphere at a second temperature” was not carried out. The obtained midsole precursor was directly used for shoe making to obtain shoes 5-4, shoes C1, shoes C2, shoes C3, shoes C4, shoes C5, and shoes C6.

### Test [Shoes 5-1 to 5-4, A1-A6, B1-B6, C1 to C6]

The obtained shoes were tested. Before testing, put on the shoes and step on them for about 30000 steps to fully activate the graphene oxide breathable channel.

Two parallel experiments are conducted for each test.

Parallel Experiment 1: [Left Foot Comparative Example 10, Right Foot Example] Exercise for one day, approximately 30000 steps.

Parallel Experiment 2: [Right Foot Comparative Example 10, Left Foot Example] Exercise for one day, approximately 30000 steps.

Compare the shoes prepared in each embodiment with the shoes prepared with the same material midsole in Comparative Example 10, evaluate the odor of both shoes, and take the average of the two experiments. Shoes 5-1 to 5-3 are compared with shoe 5-4 in Comparative Example 10 as a group, and all test values of shoe 5-4 are averaged. Shoes A1 and B1 are compared with C1 in Comparative Example 10 as a group, and all test values of shoe C1 are averaged. Shoes A2 and B2 are compared with C2 in Comparative Example 10 as a group, and all test values of shoe C2 are averaged, and so on.

Classify odors into a total of 11 levels, ranging from 0 to 10. Among them, when the odor level is 0, the odor is the smallest; When the odor level is 10, the odor is the highest.

The improvement of skin density and tear strength refers to the increase in the numerical value of the integrated visual effect area of the midsole relative to the numerical value of the non integrated visual effect area. Specifically, if the skin density in the non integrated visual area is 0.17 g/cm³ and the skin density in the integrated visual area is 0.195 g/cm³, the increase in skin density is 14.7%. It should be noted that the skin density of the integrated visual effect area is 1.3 times or higher than the density of the inner area of the midsole, and specific measurement values are not separately provided in the table. ASTM D-624 standard is used to test the tear strength of shoe soles. Firstly, a sheet with the skin having a thickness of 2 mm is cut from the test area, and then punched with a punching knife. The tear strength (unit: Kg/cm) is tested using a tensile testing machine. It should be noted that the tear strength of the integrated visual effect area is important because in general, the integrated visual effect area is prone to external shear forces during movement.

The heat resistance is obtained by measuring the Vicat softening point temperature. Resilience refers to the ability of the sole to deform upon impact and bounce the impactor, as measured according to DB35/T 1937-2020.

The mass/weight ratios of thermoplastic polyurethane and thermosetting polymer in Table 1 are 85% and 15%, respectively.

TABLE 2
Test Results

| | | | | | | | Heat | |
|---|---|---|---|---|---|---|---|---|
| | | | | | | | resistance | |
| | | | | | Integrated | Improvement in | (Vicat | |
| | | foamed | Odor | | visual | skin density and | softening | |
| Examples | | particles | level | Resilience | effect | tear strength | point) | |
| 5-1 | Solid | Example 2 | 2 | 52% | yes | Density | 250° | C. |
| | graphene | | | | | increased by | | |
| | oxide mixed | | | | | 14.7%, | | |
| | with thermal | | | | | The tear | | |
| | foaming | | | | | strength | | |
| | particles | | | | | increased from | | |
| | | | | | | 18 kg/cm to 21 | | |
| | | | | | | kg/cm, an | | |
| | | | | | | increase of | | |
| | | | | | | 16.7% | | |
| 5-2 | Mixing of | Example 2 | 2 | 52% | yes | Density | 250° | C. |
| | graphene | | | | | increased by | | |
| | oxide | | | | | 14.5%, | | |
| | suspension | | | | | The tear | | |
| | with foamed | | | | | strength | | |
| | particles | | | | | increased from | | |
| | | | | | | 18 kg/cm to 21 | | |
| | | | | | | kg/cm, an | | |
| | | | | | | increase of | | |
| | | | | | | 16.7% | | |
| 5-3 | the midsole | Example 2 | 6 | 52% | yes | Density | 250° | C. |
| | was made by | | | | | increased by | | |
| | two step | | | | | 14.6%, | | |
| | heating; | | | | | Tear strength | | |
| | graphene | | | | | increased from | | |
| | oxide was not | | | | | 18 to 21, an | | |
| | added. | | | | | increase of | | |
| | | | | | | 16.7% | | |
| 5-4 | the midsole | Example 2 | 6 | 53% | no | The epidermal | 200° | C. |
| | was made by | | | | | density is | | |
| | one step | | | | | 0.17 g/cm³ | | |
| | heating; | | | | | Tear strength of | | |
| | graphene | | | | | 18 kg/cm | | |
| | oxide was not | | | | | | | |
| | added. | | | | | | | |
| A1 | Using | Polyester | 3 | 55% | yes | Density | 120° | C. |
| | commercially | polyurethane | | | | increased by | | |
| | available | | | | | 14.7%, | | |
| | foamed | | | | | Tear strength | | |
| | particles | | | | | increased by | | |
| | without | | | | | 16.5% | | |
| A2 | adding | Polyether | 4 | 55% | yes | Density | 100° | C. |
| | graphene | polyurethane | | | | increased by | | |
| | oxide, the | | | | | 14.2%, | | |
| | midsole was | | | | | Tear strength | | |
| | prepared by | | | | | increased by | | |
| | two-step | | | | | 16.1% | | |
| A3 | heating. | Aliphatic | 3 | 55% | yes | Density | 120° | C. |
| | | Polyurethane | | | | increased by | | |
| | | | | | | 14.7%, | | |
| | | | | | | Tear strength | | |
| | | | | | | increased by | | |
| | | | | | | 16.3% | | |
| A4 | | Modified | 3 | 55% | yes | Density | 120° | C. |
| | | nylon | | | | increased by | | |
| | | elastomer | | | | 15.1%, | | |
| | | Pe3ax | | | | Tear strength | | |
| | | | | | | increased by | | |
| | | | | | | 16.2% | | |
| A5 | | Polyester | 4 | 55% | yes | Density | 180° | C. |
| | | elastomer | | | | increased by | | |
| | | TPEE | | | | 13.8%, | | |
| | | | | | | Tear strength | | |
| | | | | | | increased by | | |
| | | | | | | 16.1% | | |
| A6 | | Ethylene | 3 | 55% | yes | Density | 90° | C. |
| | | vinyl | | | | increased by | | |
| | | acetate | | | | 14.3%, | | |
| | | copolymer | | | | Tear strength | | |
| | | EVA | | | | increased by | | |
| | | | | | | 16.2% | | |
| B1 | Using | Polyester | 3 | 55% | yes | Density | 120° | C. |
| | commercially | polyurethane | | | | increased by | | |
| | available | | | | | 14.7%, | | |
| | foamed | | | | | Tear strength | | |
| | particles, | | | | | increased by | | |
| | adding | | | | | 16.4% | | |
| | graphene | | | | | | | |
| B2 | oxide by | Polyether | 4 | 55% | yes | Density | 100° | C. |
| | suspension | polyurethane | | | | increased by | | |
| | method, and | | | | | 14.2%, | | |
| | two-step | | | | | Tear strength | | |
| | heating to | | | | | increased by | | |
| | prepare the | | | | | 16.2% | | |
| B3 | midsole. | Aliphatic | 3 | 55% | yes | Density | 120° | C. |
| | | Polyurethane | | | | increased by | | |
| | | | | | | 14.7%, | | |
| | | | | | | Tear strength | | |
| | | | | | | increased by | | |
| | | | | | | 16.2% | | |
| B4 | | Modified | 3 | 55% | yes | Density | 120° | C. |
| | | nylon | | | | increased by | | |
| | | elastomer | | | | 15.1%, | | |
| | | Pebax | | | | Tear strength | | |
| | | | | | | increased by | | |
| | | | | | | 16.1% | | |
| B5 | | Polyester | 4 | 55% | yes | Density | 180° | C. |
| | | elastomer | | | | increased by | | |
| | | TPEE | | | | 13.8%, | | |
| | | | | | | Tear strength | | |
| | | | | | | increased by | | |
| | | | | | | 16.4% | | |
| B6 | | Ethylene | 3 | 55% | yes | Density | 90° | C. |
| | | vinyl | | | | increased by | | |
| | | acetate | | | | 14.3%, | | |
| | | copolymer | | | | Tear strength | | |
| | | EVA | | | | increased by | | |
| | | | | | | 16.1% | | |
| C1 | Using | Polyester | 7 | 55% | no | | 120° | C. |
| | commercially | polyurethane | | | | | | |
| | available | | | | | | | |
| C2 | foamed | Polyether | 8 | 55% | no | | 100° | C. |
| | particles | polyurethane | | | | | | |
| | without | | | | | | | |
| C3 | adding | Aliphatic | 6 | 55% | no | | 120° | C. |
| | graphene | Polyurethane | | | | | | |
| | oxide, | | | | | | | |
| C4 | one-step | Modified | 7 | 55% | no | | 120° | C. |
| | heating is used | nylon | | | | | | |
| | to prepare the | elastomer | | | | | | |
| | midsole. | Pebax | | | | | | |
| C5 | | Polyester | 8 | 55% | not | | 180° | C. |
| | | elastomer | | | | | | |
| | | TPEE | | | | | | |
| C6 | | Ethylene | 5 | 55% | no | | 90° | C. |

vinyl
acetate
copolymer
EVA

The above specifically illustrates and describes exemplary embodiments of the present disclosure. It should be understood that this disclosure is not limited to the detailed structure, setting method, or Embodiment described herein. On the contrary, this disclosure intends to encompass various modifications and equivalent settings contained within the spirit and scope of the appended claims.

1. Method for preparing a thermosetting midsole using foamed particles with graphene oxide on surface, the method comprising:
fusing the foamed particles with graphene oxide on surface with each other in a midsole mold under steam heating conditions to form the thermosetting midsole,
wherein a body of the foamed particles with graphene oxide on surface is formed by mixing 60 wt % to 95 wt % of thermoplastic polyurethane and 5 wt % to 40 wt % of thermosetting polymer of the foamed particles and foaming under non curing conditions.

2. The method according to claim 1, wherein the amount of graphene oxide is 0.05 wt % to 2 wt % of the foamed particles.

3. The method according to claim 1, wherein the foamed particles with graphene oxide on surface are prepared as follows:
foaming a mixture of 60 wt % to 95 wt % thermoplastic polyurethane and 5 wt % to 40 wt % thermosetting polymer under non curing conditions to form the body of the foamed particles, based on the total weight of the body of the foamed particles; and
contacting the suspension of graphene oxide with the body of the foamed particles to obtain the foamed particles with graphene oxide on surface.

4. The method according to claim 2, wherein the graphene oxide is sulfonated graphene, and the sheet diameter of the sulfonated graphene is greater than or equal to 100 microns to less than 1000 microns; and the respective thicknesses of the sulfonated graphene are 5 to 10 nanometers.

5. The method according to claim 1, wherein
the midsole is a midsole with an integrated visual effect, and at least some areas of the midsole with an integrated visual effect have an integrated visual effect, that is, there is no popcorn like pattern in that area, which is called an integrated visual area; and
the mold is a porous mold, and the visual part corresponding to the integrated molding visual area is provided with multiple first ventilation holes, wherein the area of each first ventilation hole is 0.01 square millimeters to 0.25 square millimeters, and the number of first ventilation holes is greater than 50 per square centimeter,
the method further comprising:
placing the foamed particles in the mold, introducing steam at a first temperature into the mold to perform secondary foaming on the foamed particles and fusing them together to form a midsole precursor; and
maintaining one or more of the molds in an atmosphere at a second temperature, wherein the second temperature is higher than the first temperature, so that an integrated visual effect is formed in the integrated molding visual area of the midsole precursor, to form the midsole.

6. The method according to claim 5, wherein the integrated visual effect comprises: the integrated visual area does not contain popcorn like patterns, and the integrated visual area includes fine patterns, which are pattern features with a size of 0.2 mm to 2.0 mm, including one or more of protrusions, fine patterns, and depressions, and the size of the pattern feature refers to the minimum size of the pattern feature.

7. The method according to claim 1, wherein the thermosetting polymer is selected from a group consisting of:
thermosetting phenolic resin, thermosetting urea formaldehyde resin, thermosetting melamine formaldehyde resin, thermosetting epoxy resin, thermosetting polyimide, thermosetting polyether nylon elastomer (PEBax), thermosetting polyester elastomer (TPEE), thermosetting ethylene vinyl acetate polymer (EVA), and thermosetting polyurethane.

8. The method according to claim 5, wherein the integrated visual effect area comprises the side of the midsole.

9. The method according to claim 5, wherein
the first temperature is between the softening point temperature of the foamed particles and a temperature 18° C. higher than the softening point temperature, and the processing time is 1 minute to 5 minutes; and
the second temperature is a temperature that is 20° C. to 30° C. higher than the first temperature, and the processing time is 1 minute to 5 minutes.

10. A midsole prepared by the method according to claim 1.

11. The midsole according to claim 10, wherein the midsole has an integrated visual effect, wherein the midsole with an integrated visual effect is made by secondary foaming of foamed particles in a mold, and at least some areas have an integrated visual effect, that is, there is no popcorn like pattern in that area, which is called an integrated visual area, wherein the integrated visual area includes the side of the midsole,
the midsole further comprising an area visually having a popcorn like pattern, called a non integrated visual area, wherein the skin density of the integrated visual area is 1.1 times or higher than that of the non integrated visual area, and the skin density of the integrated visual area is 1.3 times or higher than that of the internal area of the midsole.

12. A shoe comprising the midsole according to claim 10.

13. A method for preparing shoes comprising preparing a midsole according to claim 1.
